(19) United States
(12) Patent Application Publication
(10) Pub. No.: US 2020/0258702 A1
(43) Pub. Date: Aug. 13, 2020

(54) GAS CIRCUIT BREAKER OF GAS-INSULATED SWITCHGEAR

(71) Applicant: HYOSUNG HEAVY INDUSTRIES CORPORATION, Seoul (KR)

(72) Inventors: Seung Kyu LEE, Changwon-si Gyeongsangnam-do (KR); Kwang Jin KIM, Changwon-si Gyeongsangnam-do (KR); So Hae CHOI, Changwon-si Gyeongsangnam-do (KR); Chang Hwan YANG, Changwon-si Gyeongsangnam-do (KR); Won Ho CHOI, Changwon-si Gyeongsangnam-do (KR)

(21) Appl. No.: 16/647,996

(22) PCT Filed: May 28, 2018
(86) PCT No.: PCT/KR2018/006025

§ 371 Date: Mar. 17, 2020

(30) Foreign Application Priority Data
Sep. 18, 2017 (KR) 10-2017-0119841

(51) Int. Cl. H01H 33/42; H01H 33/12

(52) U.S. Cl. CPC H01H 33/42; H01H 33/7015; H01H 33/122

(57) ABSTRACT

A gas circuit breaker of a gas-insulated switchgear is proposed. The gas circuit breaker includes a driving part (10) that operates when fault current occurs, and a fixed part (20) that is coupled to and separated from the driving part (10), thereby establishing electric connection. The driving part (10) includes a first main electrode (12) and a first arc electrode (14). The fixed part (20) includes a second main electrode (22) that is coupled to and separated from the first main electrode (12). The fixed part (20) also includes a second arc electrode (24). The first arc electrode (14) and the second arc electrode (24) are separated after separation of the first and second main electrodes (12, 22), thereby generating an arc. A first activation lever (30) is connected to a first connection link (19). A second activation lever (40) is connected to the first activation lever (30).

### TECHNICAL FIELD

The present invention generally relates to a gas circuit breaker of a gas-insulated switchgear. More particularly, the present invention relates to a gas circuit breaker of a gas-insulated switchgear, wherein the arc contacts of a driving part and a fixed part are simultaneously moved so as to generate relative speed therebetween.

### BACKGROUND ART

A gas insulated switchgear (GIS) is a power substation in which insulating gas having excellent insulating and extinguishing performances as an insulating medium is used to store conductors and various protective devices in a metal sealed container, thereby improving reliability, and has various components such as a circuit breaker, a disconnector, and a ground breaker therein.

When fault occurs in a power system, the fault current is required to be quickly and safely stopped to protect the system and various power equipment. A device that stops fault current is called a circuit breaker, and the circuit breaker is classified into a vacuum circuit breaker, an oil circuit breaker, and a gas circuit breaker depending on an extinguishing and insulating medium. Stopping fault current by the circuit breaker means extinguishing arc occurring between two contacts during the stopping of the fault current. The gas circuit breaker is classified into a puffer type extinguishing method, a rotary arc extinguishing method, a thermal expansion extinguishing method, and a compound extinguishing method depending on an arc extinguishing method.

The stopping of fault current is performed in the gas circuit breaker. When electrodes are separated from each other in case that a high voltage flows in an electric circuit, arc occurs. The gas circuit breaker has arc electrodes connected to each other, which are a fixed arc electrode and a movable arc electrode, and allows arc to occur only between the arc electrodes. That is, the gas circuit breaker allows arc to be concentrated in one place so that the arc can be easily extinguished.

Arc occurs when contact between the fixed arc electrode and the movable arc electrode is released, and there is a method in which the fixed arc electrode as well as the movable arc electrode are moved to increase relative speed between the fixed arc electrode and the movable arc electrode. A technology of increasing relative speed between the fixed arc electrode and the movable arc electrode to increase arc-related performance is disclosed in documents of the related art. However, in the documents, since the fixed arc electrode is moved at the same time when the movable arc electrode is moved, relative speed therebetween cannot be increased to at least a predetermined extent. That is, since the movable arc electrode and the fixed arc electrode cannot be separated from each other in shorter time, there is a problem that much arc occurs.

Accordingly, when the movable arc electrode and the fixed arc electrode are always connected to each other and operated together, there is a problem in that manipulating force used for disconnecting the movable arc electrode from the fixed arc electrode cannot be efficiently used.

### DISCLOSURE

### Technical Problem

The present invention has been made keeping in mind the above problems occurring in the prior art, and the present invention is intended to propose a gas circuit breaker, in which a second arc electrode of a fixed part and a driving part do not always move together and the second arc electrode of the fixed part is allowed to move only in a predetermined section to efficiently use manipulating force.

The present invention is further intended to propose a gas circuit breaker, in which a first arc electrode and a second arc electrode are separated from each other in a section in which the second arc electrode of a fixed part and the first arc electrode of a driving part move together so that instantaneous speed is relatively high during the separation.

### Technical Solution

In order to accomplish the above objectives, the present invention provides a gas circuit breaker of a gas-insulated switchgear, the gas circuit breaker including: a driving part having a first main electrode and a first arc electrode and operating when fault current occurs, a fixed part having a second main electrode performing electrical connection by coming into contact with the first main electrode, and a second arc electrode performing electrical connection by coming into contact with the first arc electrode and separated from the first arc electrode after separation of the first main electrode from the second main electrode, a first activation lever transmitting driving power transmitted by the driving part during the operation of the driving part and having a first interlocking cam, and a second activation lever having a second interlocking cam operating in cooperation with the first interlocking cam of the first activation lever, and receiving rotational force from the first activation lever due to cooperative operation of the first interlocking cam and the second interlocking cam in a predetermined section and transmitting the rotational force to the second arc electrode.

Each of the first activation lever and the second activation lever may be rotated relative to a rotation center, and the first interlocking cam of the first activation lever may have a first interlocking surface and a second interlocking surface with an angle therebetween, the angle being larger than an angle of a portion of the second interlocking cam corresponding thereto.

The second interlocking cam may have a first interlocking surface corresponding to the first interlocking surface of the first interlocking cam and have a second interlocking surface corresponding to the second interlocking surface of the first interlocking cam, so the first interlocking surfaces may be in contact with each other such that the first activation lever and the second activation lever operate integrally, and the second interlocking surfaces may be in contact with each other such that the first activation lever and the second activation lever operate integrally.

The first activation lever may have a first connection part at a side opposite to a portion of the first activation lever rotatably connected to the second activation lever, the first connection part being connected to a first connection link transmitting the driving power of the driving part.

The second activation lever may have a second connection link at a side opposite to a portion of the second activation lever rotatably connected to the first activation lever, the second connection link being connected to the second arc electrode.

The first connection part in which an interlocking pin of the first connection link receiving the driving power of the driving part is located may be provided in the first activation lever.

The first connection part may have a straight line portion and a curved portion, wherein distance between the rotation center of each of the first activation lever and the second activation lever and the straight line portion may be changed according to a position of the straight line portion and distance between the rotation center and the curved portion may be constant irrespective to a position of the curved portion.

### Advantageous Effects

The gas circuit breaker of a gas-insulated switchgear of the present invention has the following effects.

In the present invention, to operate the second arc electrode of the fixed part, manipulating force provided by the driving part is not used in the entire operation section of the driving part, but is used only in a section in which the first arc electrode and the second arc electrode are separated from each other. Accordingly, the manipulating force is used only when the manipulating force of the driving part is required, so the manipulating force is efficiently used.

In addition, in the present invention, there is a time at which the first arc electrode is separated from the second arc electrode in a section in which the second arc electrode of the fixed part is moved by being driven by the driving part. Accordingly, instantaneous speed is increased and arc occurrence time is shortened at the time at which the first arc electrode is separated from the second arc electrode.

### DESCRIPTION OF DRAWINGS

FIG. 1 is a sectional view illustrating a gas circuit breaker of a gas-insulated switchgear according to an exemplary embodiment of the present invention.

FIG. 2 is a top plan view illustrating main portions illustrated in FIG. 1 according to the embodiment.

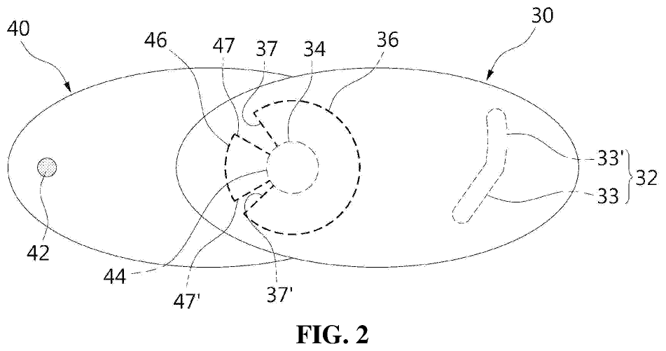

FIG. 3 shows top plan views illustrated by separating the main portions illustrated in FIG. 2.

FIG. 4 shows operation state views illustrating sequentially states during the introduction of a driving part to a fixed part in the gas circuit breaker according to the embodiment of the present invention.

FIG. 5 shows operation state views illustrating sequentially states during the disconnection of the driving part from the fixed part according to the embodiment of the present invention.

### MODE FOR INVENTION

Hereinbelow, an exemplary embodiment of the present invention will be described in detail with reference to the accompanying drawings. In adding reference numerals to the components of each drawing, it should be noted that the same reference numerals are assigned to the same components as much as possible even though they are shown in different drawings. In addition, in describing the embodiment of the present invention, if it is determined that the detailed description of the related known configuration or function interferes with the understanding of the embodiment of the present invention, the detailed description thereof will be omitted.

In addition, in describing the components of the embodiments of the present invention, terms such as first, second, A, B, (a), and (b) may be used. These terms are only for distinguishing the components from other components, and the nature and order, etc. of the components are not limited by the terms. If a component is described as being “connected”, “combined”, or “coupled” to another component, the component may be directly connected or combined with the another component, but it should be understood that still another component may be “connected”, “combined”, or “coupled” to each of the components therebetween.

As illustrated in the drawings, according to a gas circuit breaker of the present invention, a driving part 10 includes a first main electrode 12. The first main electrode 12 is approximately configured in a shape of a cylinder and has a first arc electrode 14 at a center of an inner part thereof. The first main electrode 12 is in contact with a second main electrode 22 to be described below to perform a power connection thereto. The first arc electrode 14 is in contact with and is separated from a second arc electrode 24 to be described below. When a driving part 10 is introduced into a fixed part 20, contact between the first arc electrode 14 and the second arc electrode 24 occurs more quickly than contact between the first main electrode 12 and the second main electrode 22. When the driving part 10 is disconnected from the fixed part 20, the separation of the first arc electrode 14 from the second arc electrode 24 occurs after the separation of the first main electrode 12 from the second main electrode 22, which allows arc to occur only between the first arc electrode 14 and the second arc electrode 24. The first arc electrode 14 is approximately cylindrical.

The driving part 10 includes a nozzle 16. The nozzle 16 serves to spray gas for extinguishing an arc when the arc occurs between the first arc electrode 14 and the second arc electrode 24 to be described below. Gas existing in a puffer chamber 18 provided inside the driving part 10 is transferred to the nozzle 16 and is discharged therethrough. A first connection link 19 is provided at a front end of the nozzle 16 and is connected to a first activation lever 30 to be described below. The first connection link 19 serves to transfer driving power of the driving part 10 to the second arc electrode 24 which will be described below.

A fixed part 20 corresponding to the driving part 10 includes the second main electrode 22. In the embodiment, the second main electrode 22 constitutes the appearance of the fixed part 20. The second main electrode 22 is coupled to the first main electrode 12 to perform electrical connection thereto. Substantially, the driving part 10 and the fixed part 20 play the role of allowing electric current to flow as a whole, and the first main electrode 12 and the second main electrode 22 mainly play the role of allowing the electric current to flow.

The second arc electrode 24 is provided at the center of the second main electrode 22 along a longitudinal direction thereof. The second arc electrode 24 is in electrical contact with the first arc electrode 14. The second arc electrode 24 is rod-shaped and inserted into the first arc electrode 14. The second arc electrode 24 is movable relative to the entirety of the fixed part 20. The second arc electrode 24 is provided in the second main electrode 22 to move forward and rearward.

A second connection link 26 is connected to a rear end of the second arc electrode 24. A first end part of the second connection link 26 is connected to the second arc electrode 24, and a second end part thereof is rotatably connected to a second activation lever 40 to be described below. The second connection link 26 receives the driving power of the driving part 10 through the first connection link 19, the first activation lever 30, and the second activation lever 40, which will be described below, and allows the second arc electrode 24 to move at a predetermined time.

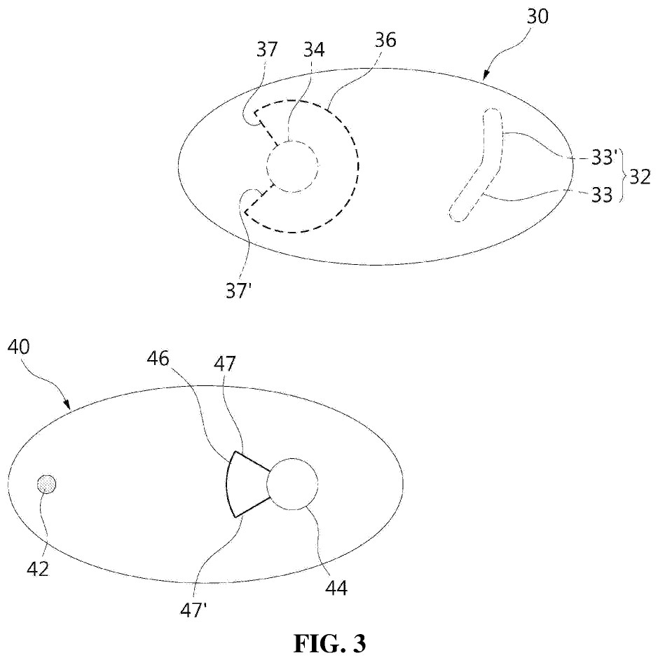

The first activation lever 30 is rotatably connected to the first connection link 19. The first connection link 19 is connected to a first end part of the first activation lever 30, and the second activation lever 40 to be described below is rotatably connected to a second end part of the first activation lever 30. The configuration of the first activation lever 30 is well illustrated in FIG. 3. The first activation lever 30 includes a first connection part 32. The first connection part 32 is a channel having a predetermined shape. An interlocking pin (no reference numeral) provided in the first connection link 19 is located at the first connection part 32. The interlocking pin transmits the driving power for the movement of the second arc electrode 24 only in a predetermined section while moving along the first connection part 32. That is, the first connection part 32 includes a straight line portion 33 and a curved portion 33′, and when the interlocking pin is moved in the straight line portion 33, the driving power is transmitted to the first activation lever 30. However, when the interlocking pin is moved along the curved portion 33′, the driving power is not transmitted to the first activation lever 30. This is because the power transmission occurs due to the change of distance from a first rotation center 34 to the first connection part 32. The power transmission does not occur in a section in which distance from the first rotation center 34 to the first connection part 32 is not changed, but occurs in a section in which the distance is changed.

A first rotation center 34 is provided at a portion at which the first activation lever 30 is connected to the second activation lever 40 to be described below. The first activation lever 30 rotates relative to the first rotation center 34. A first interlocking cam 36 is provided at the first rotation center 34 of the first activation lever 30. In a top plan view as illustrated in the drawing, the first interlocking cam 36 is generally circular, but has a portion removed by a predetermined angle. A first side surface of the portion removed by the predetermined angle is a first interlocking surface 37, and a second side surface thereof located at a side opposite thereto is a second interlocking surface 37′. The first interlocking surface 37 and the second interlocking surface 37′ are provided such that the first interlocking cam 36 operates in cooperation with a second interlocking cam 46.

The second connection link 26 is rotatably connected to a first end part of the second activation lever 40. A second rotation center 44 is provided in a second end part of the second activation lever 40. The second rotation center 44 and the first rotation center 34 are configured to have a shaft and a shaft hole to correspond to each other so that relative rotation therebetween is possible. The second interlocking cam 46 is provided to be adjacent to the second rotation center 44. The second interlocking cam 46 is provided on a surface facing a surface of the first activation lever 30 on which the first interlocking cam 36 is located. The second interlocking cam 46 has a first interlocking surface 47 and a second interlocking surface 47′ corresponding to the first interlocking surface 37 and the second interlocking surface 37′ of the first interlocking cam 36, respectively, and controls the transmission of the driving power between the first activation lever 30 and the second activation lever 40.

An angle which the first interlocking surface 37 and the second interlocking surface 37′ of the first interlocking cam 36 define is larger than an angle which the first interlocking surface 47 and the second interlocking surface 47′ of the second interlocking cam 46 define. Accordingly, the second interlocking cam 46 located between the first interlocking surface 37 and the second interlocking surface 37′ of the first interlocking cam 36 operates in cooperation with the first interlocking cam 36 only in some sections of an entire movement section of the first activation lever 40.

Meanwhile, the first connection part 32 includes the straight line portion 33 and the curved portion 33′, and power can be transmitted only when the interlocking pin of the first connection link 19 moves along the straight line portion 33, and power can be transmitted only in a predetermined section even by the cooperative operation of the first interlocking cam 36 and the second interlocking cam 46. Accordingly, it is not necessarily required that the first connection part 32 has the straight line portion 33 and the curved portion 33′. That is, only the configuration of the first interlocking cam 36 and the second interlocking cam 46 allows power to be transmitted in a predetermined section.

In addition, the first connection part 32 is configured to include the straight line portion 33 and the curved portion 33′, and allows the speed ratio of the vertical translation of the driving part 10 and the second arc electrode 24 of the fixed part 20 to be adjusted in a specific section. Furthermore, similar configuration is applied to a second connection part 42 as well as to the first connection part 32, so the speed ratio can be adjusted. In the first connection part 32 and the second connection part 42, the speed ratio is adjusted according to straight distance ratios from the rotation centers 34 and 44 to the connection parts 32 and 42.

Hereinbelow, the operation of the gas circuit breaker of a gas-insulated switchgear of the present invention having the above-described configuration will be described in detail.

In the gas circuit breaker, the first and second main electrodes 12 and 22 are in contact with or separated from each other while the driving part 10 moves relative to the fixed part 20. That is, in the introduced state, the first and second main electrodes 12 and 22 are in contact with each other, and in the disconnected state, the first and second main electrodes 12 and 22 are separated from each other. Of course, the first and second arc electrodes 14 and 24 are also in contact with or separated from each other in the same way. However, the time of the contact and separation of the first and second main electrodes 12 and 22 is different from the time of contact and separation of the first and second arc electrodes 14 and 24 as described above.

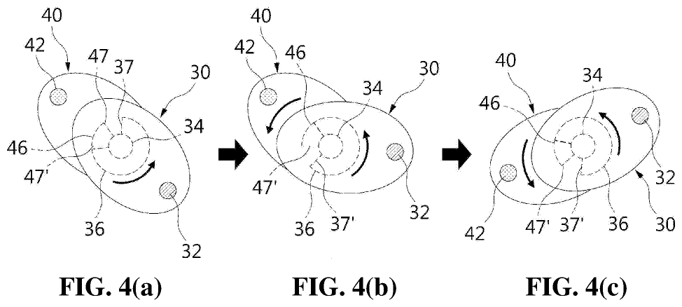

Referring to FIG. 4, the introduction operation will be described. For reference, FIG. 4, illustrates a state in which the straight line portion 33 and the curved portion 33′ are not provided in the first connection part 32. That is, when the first connection link 19 is driven, the first activation lever 30 is configured to be always operated.

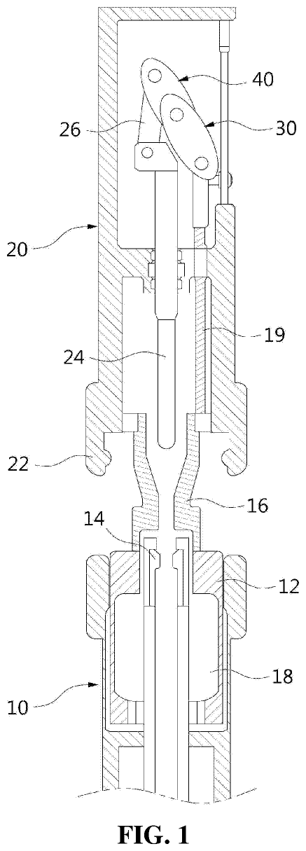

In a state prior to the introduction, that is, in an open state, as illustrated in FIG. 1, the first and second main electrodes 12 and 22 are separated from each other. Of course, the first and second arc electrodes 14 and 24 are also separated from each other. In this state, the driving part 10 moves toward the fixed part 20 and is introduced thereto.

In the process, while the first connection link 19 is pushed by the movement of the driving part 10, the first activation lever 30 is rotated counterclockwise relative to the first rotation center 34. This state is illustrated in FIG. 4(a). In this case, the second activation lever 40 does not move since the first interlocking cam 36 and the second interlocking cam 46 are not yet interlocked.

From the time at which the first interlocking surface 37 of the first interlocking cam 36 is brought into contact with the first interlocking surface 47 of the second interlocking cam 46 by the rotation of the first activation lever 30, the second activation lever 40 is rotated. Accordingly, in FIG. 4(b), the first activation lever 30 is rotated counterclockwise, and the second activation lever 40 is also rotated counterclockwise.

From the time at which the first activation lever 30 and the second activation lever 40 are rotated together, the second arc electrode 24 is moved toward the nozzle 16 by the second connection link 26. The second arc electrode 24 is introduced into the first arc electrode 14 by such operation to be electrically connected thereto. Of course, in FIG. 4(c), the first main electrode 12 is combined with the second main electrode 22 to be electrically connected thereto.

When fault current occurs while the introduction is completed in FIG. 4(c), a signal of operating the driving part 10 is provided, and the driving part 10 is moved in a direction going away from the fixed part 20, so that the first main electrode 12 and the second main electrode 22 are moved in directions separating from each other. In this process, cooperative operation between the first activation lever 30 and the second activation lever 40 will be described.

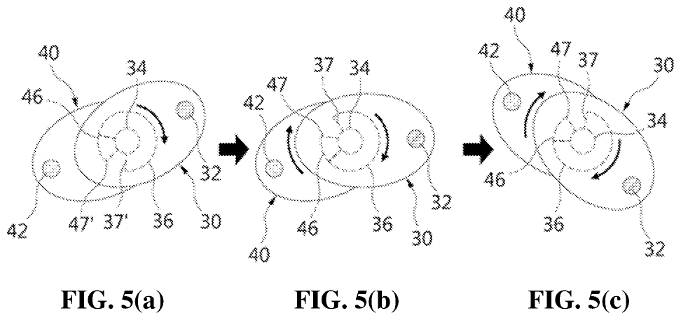

FIG. 5(a) is in the same state as FIG. 4(c), and while the first connection link 19 is pulled by the driving part 10 in the beginning of opening, the first activation lever 30 connected to the first connection link 19 is rotated clockwise relative to the first rotation center 34. When the first activation lever 30 is rotated clockwise, the first interlocking surface 37 of the first interlocking cam 36 and the first interlocking surface 47 of the second interlocking cam 46 are separated from each other. Accordingly, only the first activation lever 30 is rotated and the second activation lever 40 is in a stationary state.

When the first activation lever 30 is continuously rotated, the second interlocking surface 37′ of the first interlocking cam 36 comes into contact with the second interlocking surface 47′ of the second interlocking cam 46. From this time, the first activation lever 30 and the second activation lever 40 are rotated together. That is, as illustrated in FIG. 5(b), the first activation lever 30 and the second activation lever 40 are all rotated clockwise relative to the rotation centers 34 and 44, respectively.

The rotation of the first activation lever 30 and the second activation lever 40 together is performed until the state of FIG. 5(c), that is, until the open state, which is the state of FIG. 4(a). That is, the disconnection is completed.

Meanwhile, when the straight line portion 33 and the curved portion 33′ are provided in the first connection part 32, the first activation lever 30 is rotated while the interlocking pin of the first connection link 19 moves along the straight line portion 33. However, the rotation of the first activation lever 30 is not performed while the interlocking pin moves along the curved portion 33′. Here, the speed ratio of the vertical translation between the driving part 10 and the fixed part 20 can be changed by the adjustment of distance from each position of the straight line portion 33 to the first rotation center 34. The speed of the separation of the first arc electrode 14 from the second arc electrode 24 at the time at which the first arc electrode 14 and the second arc electrode 24 are separated from each other can be adjusted by changing the speed ratio, so that an arc occurs for shorter time.

The time at which the first arc electrode 14 and the second arc electrode 24 move simultaneously can be set by the cooperative operation of the first interlocking cam 36 and the second interlocking cam 46, and the speed ratio of the driving part 10 and the fixed part 20, that is, the relative speed between the first arc electrode 14 and the second arc electrode 24 can be set by the power transmission and the stopping of the transmission caused by the straight line portion 33 and the curved portion 33′ of the first connection part 32.

In such a method, the driving power produced by the movement of the driving part 10 is used only in a specific section to move the second arc electrode 24 via the first connection link 19. That is, when the first arc electrode 14 and the second arc electrode 24 are separated from each other, the first arc electrode 14 and the second arc electrode 24 are moved simultaneously, so that the separation of the first arc electrode 14 from the second arc electrode 24 occurs more quickly.

In the above description, although it is described that all the components constituting the embodiment of the present invention are integrally combined or operated in combination, the present invention is not necessarily limited to such an embodiment. That is, within the scope of the present invention, all of the components may be operated in at least one selective combination. In addition, the terms “comprise”, “constitute”, or “have” described above mean that corresponding components may be included unless specifically stated otherwise. Accordingly, it should be construed that other components are not excluded, but may further be included. All terms including technical and scientific terms have the same meanings as commonly understood by those skilled in the art unless otherwise defined. Commonly used terms such as terms defined in a dictionary should be interpreted to coincide with the contextual meaning of the related art, and shall not be interpreted in an ideal or excessively formal sense unless explicitly defined in the present invention.

The above description is merely illustrative of the technical idea of the present invention, and various modifications and variations may be made without departing from the essential characteristics of the present invention by those skilled in the art to which the present invention pertains. Accordingly, the embodiment disclosed in the present invention is not intended to limit the technical idea of the present invention but to describe the present invention, and the scope of the technical idea of the present invention is not limited by the embodiment. The scope of protection of the present invention should be interpreted by the following claims, and all technical ideas within the scope equivalent thereto should be construed as being included in the scope of the present invention.

1. A gas circuit breaker of a gas-insulated switchgear, the gas circuit breaker comprising:
a driving part having a first main electrode and a first arc electrode and operating when fault current occurs;
a fixed part having a second main electrode performing electrical connection by coming into contact with the first main electrode, and a second arc electrode performing electrical connection by coming into contact with the first arc electrode and separated from the first arc electrode after separation of the first main electrode from the second main electrode;
a first activation lever transmitting driving power transmitted by the driving part during the operation of the driving part and having a first interlocking cam; and
a second activation lever having a second interlocking cam operating in cooperation with the first interlocking cam of the first activation lever, and receiving rotational force from the first activation lever due to cooperative operation of the first interlocking cam and the second interlocking cam in a predetermined section and transmitting the rotational force to the second arc electrode.

2. The gas circuit breaker of claim 1, wherein each of the first activation lever and the second activation lever is rotated relative to a rotation center, and the first interlocking cam of the first activation lever has a first interlocking surface and a second interlocking surface with an angle therebetween, the angle being larger than an angle of a portion of the second interlocking cam corresponding thereto.

3. The gas circuit breaker of claim 2, wherein the second interlocking cam has a first interlocking surface corresponding to the first interlocking surface of the first interlocking cam and has a second interlocking surface corresponding to the second interlocking surface of the first interlocking cam, so the first interlocking surfaces are in contact with each other such that the first activation lever and the second activation lever operate integrally, and the second interlocking surfaces are in contact with each other such that the first activation lever and the second activation lever operate integrally.

4. The gas circuit breaker of claim 3, wherein the first activation lever has a first connection part at a side opposite to a portion of the first activation lever rotatably connected to the second activation lever, the first connection part being connected to a first connection link transmitting the driving power of the driving part.

5. The gas circuit breaker of claim 4, wherein the second activation lever has a second connection link at a side opposite to a portion of the second activation lever rotatably connected to the first activation lever, the second connection link being connected to the second arc electrode.

6. The gas circuit breaker of claim 1, wherein a first connection part in which an interlocking pin of the first connection link receiving the driving power of the driving part is located is provided in the first activation lever.

7. The gas circuit breaker of claim 6, wherein the first connection part has a straight line portion and a curved portion, wherein distance between the rotation center of each of the first activation lever and the second activation lever and the straight line portion is changed according to a position of the straight line portion and distance between the rotation center and the curved portion is constant irrespective to a position of the curved portion.
